(19) United States
(12) Patent Application Publication
(10) Pub. No.: US 2009/0083633 A1
(43) Pub. Date: Mar. 26, 2009

(54) SYSTEM AND METHOD FOR CONSOLIDATING MULTIPLE TRANSACTIONS

(76) Inventor: Paul Joseph Toner, Aurora, CO (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/204,166

(22) Filed: Sep. 4, 2008

Related U.S. Application Data
(60) Provisional application No. 60/969,794, filed on Sep. 4, 2007.

(51) Int. Cl. G06F 3/00

(52) U.S. Cl. 715/733

(57) ABSTRACT

A system for initiating multi-faceted transactions facilitating ancillary services includes a server connected to a network, a database, and a web-based interface configured to allow interaction between the server and a first user connected to the network, wherein the server is configured to receive, store, secure, and back-up data, format the data into at least one of a plurality of formats, transmit the formatted data to at least a first service provider connected to the network. A method for integrating business transactions includes providing an established group of services, uploading customer data to a database securely through a web-based interface, formatting the customer data to reflect at least one industry specification, and transmitting the formatted customer data to at least one service provider, the service provider representing one of the established group of services.

### CROSS REFERENCE TO RELATED APPLICATIONS

The present application claims priority to U.S. Provisional Patent Application No. 60/969,794, which was filed on Sep. 4, 2007, the content of which is hereby incorporated herein by reference in its entirety.

### FIELD OF THE INVENTION

The present invention relates to a system and method for facilitating transactions. More particularly the present invention relates to a system with a web-based interface which facilitates a method of business transactions with multiple service providers and provides additional business support.

### BACKGROUND

Currently, many industries are fragmented in such a manner that it requires each activity necessary to transact a purchase and sale to involve multiple interactions of persons among many ‘mini’ industries which creates inefficiency, security risk, inconvenience, and higher costs to consumers. For example a single home purchase may involve interacting with a service provider from each of the following industries: Title, Mortgage, Inspection, Contracting, Telecommunications, Moving and Transportation, Appraisal, Insurance, Contracting, Legal, Financial, and Accounting.

A buyer or seller interacting with each of these service providers may find themselves providing the same or similar information repeatedly for the same property purchase or sale. Moreover, as the buyer or seller attempts to continually monitor the status of the transaction they may find themselves having difficulty contacting their realtor or a specific service provider and thus may not be able to easily obtain the information they are looking for. From the real estate agents perspective, they may need to continually communicate with the buyer or seller in addition to monitoring the other service providers. This communication between a realtor and the various service providers as well as the buyer or seller may involve 400+phone calls in any given typical real estate transaction. Together, all of this inefficiency can cause closing delays, if not complete loss of opportunity, and often requires closing dates to be delayed by 30 days or more.

There is a need in the art for consolidation such that a buyer or seller may be allowed to minimize the several contacts with service providers when completing a transaction. There is also a need in the art for minimization of inefficient communication between the various service providers involved in the transaction. There is a further need to minimize these inefficiencies so as to expedite the time it takes to complete a transaction.

Additionally, many service providers, like realtors, are in the habit of marketing themselves via mailings either in hard copy or e-mail form. Some may even have websites advertising their services. In many instances, the service provider may not have a proper system to efficiently track, secure/protect and utilize their bundled services, nor the programming expertise to modify or update their website and often may have to contract with a web programmer on a continual basis to maintain their website. There is a need for an interface that makes service provider tasks more efficient and allows those without web programming experience to edit and update their website.

### SUMMARY

In one embodiment, a method is provided which addresses these problems by combining a software package that may allow the integration of many of these miniature industries by automating and initiating multiple transactions through an indiscriminate amount of networks and companies through a single interface.

In one embodiment, a system and method is provided for consolidating and streamlining multiple complex transactional functions in order to reduce consumer and business acquisition costs in multiple service industries.

In another embodiment, a system and method for integration of services involved in transacting real estate finance sourcing, real estate sales, and formulas is provided, which may allow these transactions to be accomplished seamlessly over internet-based platforms.

In one embodiment, a web-based, universally accessible, platform-neutral package for an industry is provided including an established group of services bundled together, wherein the group of services bundled together includes services provided by companies and businesses having a functional relationship with the industry, and further wherein a user communicates through the use of the web-based, universally accessible, platform-neutral package for an industry directly with a subgroup of the companies and businesses providing services.

In another embodiment, a system for initiating multi-faceted transactions facilitating ancillary services includes a server connected to a network, a database, and a web-based interface configured to allow interaction between the server and a first user connected to the network, where the server is configured to receive, store, secure, and back-up data, format the data into at least one of a plurality of formats, and transmit the formatted data to at least a first service provider connected to the network. In another embodiment, the formatted data is transmitted via e-mail. In another embodiment, the web-based interface includes a contacts relationship management feature. In still another embodiment, the web-based interface includes a presentation feature. In yet another embodiment, the web-based interface is configured to host a website of a user.

In another embodiment, a method for integrating business transactions includes providing an established group of services, uploading customer data to a database through a web-based interface, formatting the customer data to create custom formatted customer data, the formatting reflecting at least one industry specification, and transmitting the custom formatted customer data to at least one service provider, where the at least one service provider represents one of the established group of services. In another embodiment, the established group of services have a functional relationship with each other. In another embodiment, the established group of services all involve separate transactions ancillary to a primary transaction. In another embodiment, the transmitting step is conducted via a “We come to you” custom and secure module. In still another embodiment, the transmitting step is automatic upon receipt of the uploaded customer data. In yet another embodiment, further transactions with the established group of services is conducted by a transaction coordinator.

In another embodiment, a system or method is provided for simplifying and integrating services involved in completing complicated transactions, such as those involving real estate finance sourcing, real estate sales, and formulas allowing these to be accomplished seamlessly over internet based platforms. The system and method may utilize a myriad of technologies to educate, facilitate, automate and exchange data amongst a group. This system may be universally accessible from any web based portal of any technology platform at any time for all users.

While the present disclosure is directed toward realty transactions, further areas of applicability will become apparent from the description provided herein (insurance, power cooperatives, outside sales, etc). It should be understood that the description and specific examples are intended for purposes of illustration only and are not intended to limit the scope of the present disclosure.

### BRIEF DESCRIPTION OF THE DRAWINGS

FIG. 1 is a diagram of a network upon which the system and method may be implemented according to certain embodiments.

FIG. 2 is an information flow diagram depicting data and management functions according to certain embodiments.

FIG. 3 is a diagram of the web-based interface features available to a user, according to certain embodiments.

### DETAILED DESCRIPTION

The following detailed description relates to a system and a method relying on a web-based interface for maximizing communication and transaction efficiencies between multiple service providers. For example, a real estate agent may represent a buyer or seller in the purchase or sale of a property. The buyer or seller may generally communicate with their realtor about the transaction, but often may also talk with and provide information to several service providers including an appraiser, a loan officer, and the like. The realtor may also communicate with each of the various service providers in addition to the opposing party and their realtor in an effort to coordinate all of the efforts and close a transaction.

The system and method described herein may provide for streamlined communication and data exchange between the several entities involved in a real estate, or other transaction. This may occur using a web-based interface where the interface is supported by software adapted to receive, format, and transmit data via a functioning file. Moreover, the date may be transmitted securely to the proper parties in their preferred format, which may maximize speed and eliminate data entry. The use of the system may involve a realtor's use of the web-based interface for preparing and presenting a sales presentation to a buyer/seller for services. Once the realtor's services are selected by the buyer/seller, the web-based interface may allow for data entry relating to the buyer/seller. The software may be capable of formatting and transmitting this information to the various service providers for ancillary transactions such as an appraisal, a loan, and the like. The transmission may be encrypted and may involve a custom software module for receiving and integrating data with the destination system. Later in the process, the web-based interface may be accessible by the realtor and the buyer/seller and may also provide up to date information regarding the status of the operations of each service provider. The interface and method minimizes inefficient or miscommunication and data exchange, minimizes human error and expedites the transaction process, in a more secure, cost effective format.

The web-based interface may also include additional features directed toward marketing of a user's business. These features may include an editable website with a blog feature. These features may also include a contacts relationship management (CRM) component allowing an agent to manage and advertise to a given client base. Additionally, these features may include auto-mailers for assisting with periodic updates and notices.

While much of the following description relates to real estate transactions, those skilled in the art will understand and appreciate its utility where a transaction is taking place involving multiple service providers. Moreover, any industry involving agents who must organize their leads and could benefit from accessible web-based office applications is within the scope of the present invention.

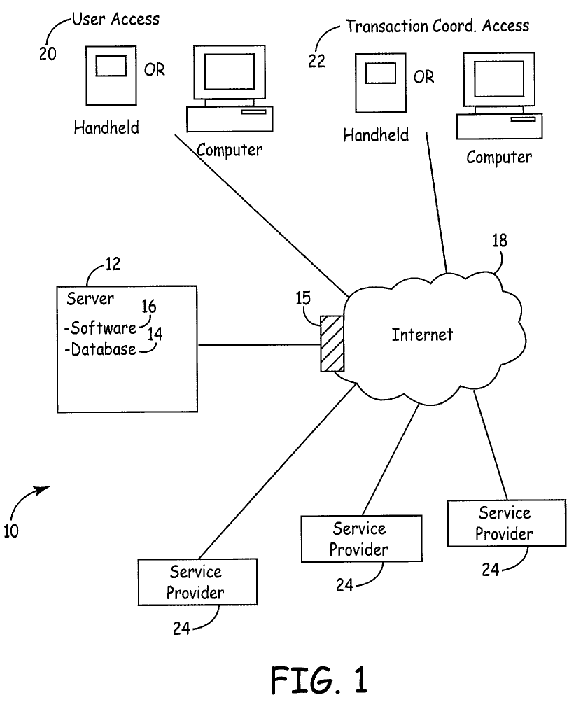

Referring to FIG. 1, a diagram is shown depicting an overall view of a network 10 upon which the system and method may be implemented. FIG. 1 shows a server 12 including a database 14 and a software module 16. The server 12 may be provided and managed by an administrator and may include a central processing unit, random access memory, a hard drive, and other like elements know by those of skill in the art. The administrator may control the capabilities of the software 16 and access to the software 16. The server 12 may be connected to the internet 18 via methods and systems known in the art. Throughout the internet 18, various entities may access the software module 16 and database 14. These entities may include a user 20, a transaction coordinator 22, various service providers 24, or any number and combination of theses entities. A web-based interface 15 to the software module 16 is accessible from anywhere in the world where internet 18 access is available. This interface 15 may be equipped with a classic view and a handheld view for access with handheld devices. Additionally, depending on the role of the entity, various levels and types of access may be available.

A user 20 of the system, as well as an associated transaction coordinator 22, may have access via a login screen to a web-based interface 15 of the software module 16. The transaction coordinator 22 may be an administrator's employee or an employee of an affiliate of the administrator. The affiliate's access may be limited to information pertinent to the affiliated party, where not automated. The access provided by the login screen allows the user 20 or transaction coordinator 22 to input information as well as monitor the status of various transactions with various service providers 24. Information provided to the service providers 24 may occur in their preferred method of delivery. This may include a customized software module that plugs in directly to their system ensuring one point of data entry, proper and preferred format, data assimilation, and security. Alternatively, information may be provided to the service provider 24 via e-mail from the software module 16, via e-mail directly from a transactions coordinator 22, or over the telephone. Still another alternative may be that the service provider 24 may have access to the software module 16 through their own web-based interface 15. In this case, a notification may be indicated on the service provider's account.

Information traveling from the service providers 24 to the software module 16 may be via e-mail directly via the customized module mentioned or via telephone to the transactions coordinator 22 who may enter the status details and information into the software module 16 through the interface 15. Alternatively, each individual, participating entity may also enter updates themselves, eliminating the need for a transactional coordinator 22. Still another alternative may be that the software module 16 may be equipped with a queue for receiving e-mails. Here the information from the service providers 24 to the software module 16 may be via e-mail directly to the software module 16 where it may sit in a queue for further processing by the transactions coordinator 22 or the appropriate affiliated entity. Yet another alternative may involve a service provider 24 having access to the software module 16 via a web-based interface 15 and thus, the service provider 24 may simply upload information and notify the transaction coordinator 22 via a notification within the software module 16. In all cases, the user 20 may also act as their own transaction coordinator 22 at any time and facilitate this information transfer.

The software module 16 and database 14 may be created using a series of programming languages integrated through a single user interface in the form of an HTML and CSS based web-based interface 15. The languages included in this series may include: AJAX, Flash, HTML, XML, .Net, FLEX and Java.

Those skilled in the art will understand and appreciate that the internet network disclosed herein reflects but one embodiment of the system. The network may be a local area network or other network. Other setups may include installation on a local drive of a machine and providing a user interface, wherein the local machine may have internet access for purposes of transmitting and receiving information via e-mail. Those skilled in the art will understand and appreciate that various other setups may be available and within the scope of the invention. Those skilled in the art will also understand and appreciate the programming necessary to implement the various elements of the described system and method.

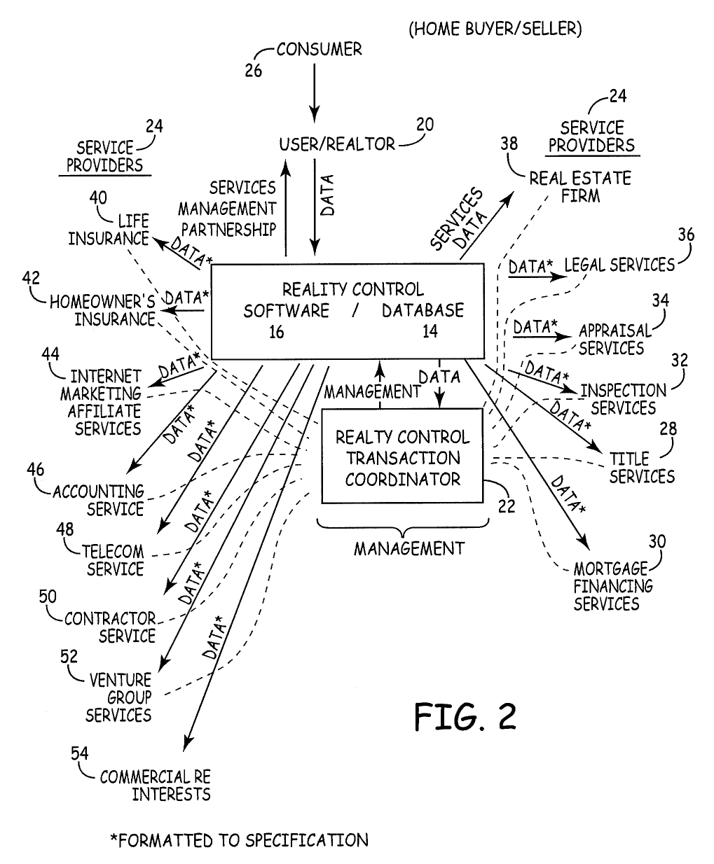

Referring to FIG. 2, an information flow diagram is shown. At the center of the diagram is a software module 16 and database 14. As shown, a consumer 26 may enter data into the system via a relationship with a user 20 of the system. In the case shown, the consumer 26 may be a buyer or seller of real estate and the user 20 may be realtor. Throughout this description, the consumer 26 may often be referred to as a client or customer. The user 20 may have access to the system through a web-based interface 15. The interface 15 may include, inter alia, a login screen where the user 20 may access the system. Having accessed the system, the user 20 may enter pertinent data about the consumer 26 as a party to various transactions.

The software module 16 and database 14 may provide a raw data storage location for all of the transactions. The raw data may then be automatically formatted to specifications as required for any or all of the necessary ancillary transactions. For example, the raw data entered by the user 20 may be formatted to fill in the necessary information on a loan application or may be used to fill out forms necessary to perform a title search, or initiate an insurance application, etc. In each case, the formatted data may then be automatically transmitted to the appropriate service provider 24 via any of the methods discussed regarding FIG. 1.

In the particular case shown, a real estate transaction is contemplated where the primary transaction is the purchase or sale of property. However, several ancillary transactions may be contemplated with several other service providers 24 offering services including, but not limited to the following: title 28, mortgage/financing 30, inspection 32, appraisal 34, legal 36, real estate 38, life insurance 40, homeowner's insurance 42, internet marketing affiliates 44, accounting 46, telecommunications 48, contracting 50, venture groups 52, and commercial real estate interest services 54.

In one embodiment of the method described, the software module 16 together with a transaction coordinator 22 may facilitate the remaining tasks after the user 20 accessed the system and entered the data regarding the consumer 26. This allows a user 20, in one example a realtor, to attend to more client focused tasks. These may include assisting in a home search and ultimately facilitating negotiations on price an other negotiable items relating to the primary transaction. Additionally, the user 20 may rely on other features of the system for marketing efforts and procuring additional business.

In facilitating the remaining tasks, a transaction coordinator 22 may contact the included service providers 24 as needed to facilitate the transaction. As each transaction progresses, the transaction coordinator 22 may update the consumer's account in the software module 16 with its status. Alternatively, if the service provider 24 has access to the software module 16 through a web-based interface 15, the service provider 24 could update the consumer's account in the software module 16 directly.

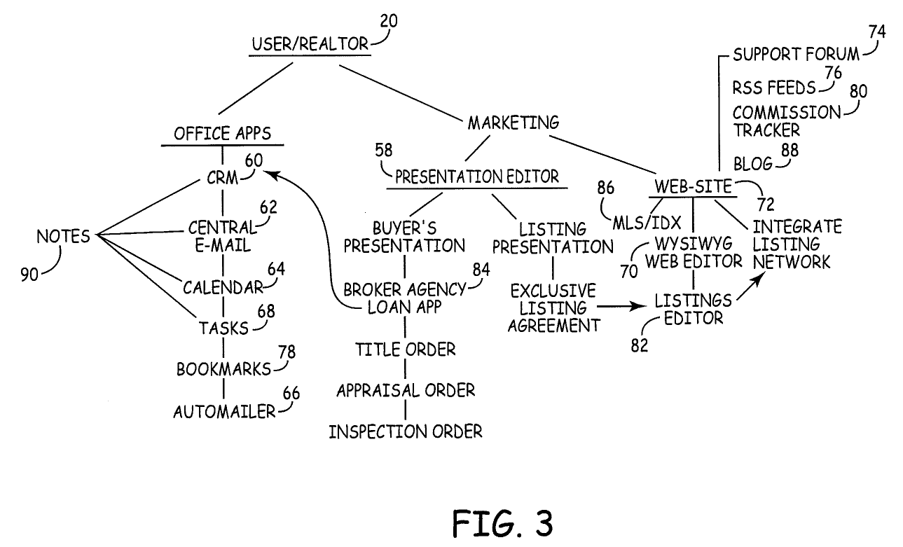

Referring now to FIG. 3, a more detailed view of the features available to a user 20 of the interface 15 will be discussed. As shown, the system may provide support for a user's business relating to the primary transaction, thus going beyond that of assisting a user 20 in managing ancillary transactions. The web-based interface 15 may include the following features: presentation support 58; contacts relationship management 60; one location e-mail 62; calendars 64; auto-mailers 66; task manager 68; website editor 70, support and hosting 72; support forum 74; RSS feeds 76; bookmark feature 78; commission tracker 80; listing editor 82; loan application feature 84; MLS feature 86, blog feature 88; and a notes feature 90. Each of these features will be discussed below. Following the discussion of each feature, further discussion of the use of some of these features is also included.

The presentation support 58 may be used by a user 20 to present himself or herself to a potential client. This feature of the web-based interface 15 allows a user 20 to customize a generic presentation template so as to carry the user's name, picture, company logo, and a brief history or background of the user 20. The template may utilize numerous, proven sales techniques, explain the benefits of working with the user 20, and may be designed to capture the broker-agency relationship in a shorter time than other available processes. Alternatively, an extended presentation may be used to educate a potential client regarding more complicated transactions.

A comprehensive contacts relationship management (CRM) system 60 may also be available. This system 60 may assist a user 20 in keeping track of consumers 26, fellow agents, companies, colleagues, etc. The system may further include the ability to take notes and store pertinent information and searches as well as provide reminders regarding events each LINKED to contacts if necessary. If requested by a full brokerage, the CRM system 60 may also allow a higher level of administration, collaboration and activity, for grouping of the contacts to enable quick efficient communication at a higher level, with permissions to see each others' schedules and request meetings where the requests are sent with auto-reminders to all e-mail participants invited. The CRM system 60 may thus provide seamless communication and integration within a personal brokerage, a client group, or a larger parent company and may allow for exchange of advice through support forums, etc.

With the CRM system 60, a user's consumer links may display all e-mails to and from this consumer 26, their contact information, any notes taken that relate to this consumer 26, any pertinent tasks, files needed, etc. New fields may be added as they emerge, and if an account was created, may include the houses they're browsing providing insights into the neighborhood, style, price-range, etc. giving the Realtor a better idea for how to target this situation. The CRM 60 may automatically document interactions. This CRM system 60 may interface with Outlook, Thunderbird, Access, or any other program, for example, via a file interface such as ‘the comma separated variable’ file. A software module may allow customized database integration by allowing the user 20 to define, or add dynamically mapped data fields allowing universal integration, regardless of database.

An e-mail feature 62 may also be made available on the web-based interface 15. This feature may provide for a “One Location” e-mail by being capable of interfacing with various e-mail accounts. Thus, a user may manage multiple accounts including those bound to a desktop e-mail account for work or family and also web based e-mails such as Yahoo, AOL, or GMAIL.

A calendars feature 64 may be available which notes appointments. This feature 64 may also be made accessible to other users. For example, a real estate agent may make their calendar accessible to other agents within the same agency so as to accommodate scheduling appointments or classes with one another.

An auto-mailer feature 66 may also be available on the web-based interface 15. This feature 66 may be programmed to automatically send e-mails to a customer list. Alternatively, the auto-mailer 66 may be programmed to print hard copies for regular mail. The system may use PHP variables to customize each e-mail or hard copy for each customer. Where hard copies are used, a label making feature may also be included.

A task manager feature 68 may also be included. This feature 68 may provide reminders to complete tasks and may track events. As mentioned regarding the CRM 60, these tasks and events may be linked with a contact or calendar event.

The system may provide a website hosting service 72 allowing a user 20 to establish a website of their own. Additionally, a web editor 70 may be included on the web-based interface 15 for customizing a user's web page. The web editor 70 may be a “What You See Is What You Get” (WYSIWYG) web editor 70, which provides for the ability to modify and customize a web page without knowledge of the programming code. Thus, a user 20 of most any experience level may be able to customize their own web page. The system may also provide for search engine optimization and indexing of a user's website to make it more apt to appear in a web search. Users 20 may also see what items or homes their customers browsed on their website, through a saved search, so they can make better determinations for their showings.

The system may also provide a centralized file storage base for users 20. Users 20 may store their contracts, photos, and/or other files that they may want to have access to on a remote basis. That is, in storing the files in the system, the systems web-based interface 15 will allow the user 20 to access the files anywhere that they have an internet connection.

The system may also offer a support forum 74 that includes the community as a whole. That is, the system may not only offer technical support, answers to questions, and administrative help, but may also provide help via user 20 to user 20 interaction. This interaction may include advice and mentoring from user 20 to user 20. In this instance, “user” may also be taken to mean anyone with access to the web-based interface including, but not limited to a service provider, a transaction coordinator, or a user 20. That is, support may cross lines associated with a particular career or job discipline.

The system may further offer web related services including RSS feeds 76 and universal-book marking 78. The RSS feeds 76 may be customized by the user 20 to provide business related updates or personal updates straight to their screen, in news format. The book marking feature 78 may keep a log of the users' categorized links making them accessible from any computer with internet access.

The system may further offer features directed to a specific business. For example, a user 20 in real estate may use a commission tracker 80 to track commissions and expenses, as well as highlight potential co-marketing options for joining a co-op. Additionally, a listings editor 82 may be provided, tailored to format their listings on their web-site, and distribute this information to affiliate co-op marketing web-sites and firms. Another real estate feature may include an MLS/IDX link 86 where a user 20 has an option to search the MLS through the brokerage/broker ID. The system may also include a loan application initiation feature 84 that allows the Realtor to take a loan application that is channeled to a co-op partner network for a co-marketing fee.

The system may also include blogging technology 88 allowing a user 20 to make quick postings to their webpage. Users 20 may use this to comment on current market conditions, daily reports, or other information deemed important to pass on to individuals browsing their webpage.

The system may also include a collapsible notes feature 90 allowing a user 20 to make notes and later quickly find previous information that was logged as important. The CRM Contact Database 60, the Notes 90, etc. can all be color-coordinated for quick reference. Additionally, the program may be translated into multiple languages including, but not limited to English, Spanish, and many Western European languages.

Use of some of the features of the system and method will now be described in detail with respect to some embodiments. Initially, a user 20 may create an account from anywhere with an internet connection, via the web-based interface 15. Once an account is created, the following above described features may be automatically created within the new account: e-mail 62, web page with WYSIWYG editor 70, personalized real estate presentations 58, personal file and storage folder, a contact database 60, a support forum 74 log-in, a blog 88, auto-mailing capabilities 66, a calendar 64, and a task Manager 68, with instant messaging and collaborative access from those among a group.

Use of the presentation feature 58 in a real estate embodiment will now be further described. As mentioned above, the presentation 58 may be customized to carry a realtor's name, picture, company logo, and a brief history or background of the realtor. The presentation template may utilize numerous, proven sales techniques and explain the benefits of working with the realtor. The template may be designed to capture the essence of the broker-agency relationship in a short period of time, such as less than one half hour.

Below is a description of an exemplary method of using a presentation to illustrate how the system may be able to uniquely satisfy the requirements for a specific set of users 20, namely real estate agents. The following is presented for a better understanding of the method of incorporating and systemizing the multiple requirements that otherwise would be cumbersome on the user 20. Thus, while the presentation feature 58 has been described, with respect to FIG. 3, as support for a user's business, the example below will also discuss the streamlining and consolidation concepts depicted in FIGS. 1 and 2 relating to minimizing interactions for various transactions. (Realty Control is the commercial name that incorporates the system in this example and may act as administrator):

Listing Presentation:
This presentation is meant to achieve and document an “Exclusive Listing Agreement.” It may document the agreement electronically, and e-mail a copy to the pertaining parties (Realtor, Employing Broker, Customer, Assistant).

Buyers Presentation:
Cover (template), then Realtor Story: WYSIWYG, Template they choose, Whatever info they want. They're in charge of this part. It should be a listing, or a buyer's presentation. Each is separate, and may consist of 4 slides or more.
Information on these slides may include: Why do they want to work with our Realtors? Benefits of the brokerage . . . Others personally, and basic-(Benefits) Sales/Marketing skills of a National Corporation, (Build Credibility) background check, fingerprinting by Colorado Bureau of Investigation. One stop Realty Shop—80% of population wants it, but only 2% of Realtors offer it. Ours do. Ability to interface with ANY lender in the country to get the best rate. Constant loan tracking status. 24/7 support electronically, and 11 hours a day with a live person.
After these slides, a slide or agreement may be included to secure “Broker/Agency” for 90-180 days, with a customer click to confirm with an “I AGREE” or “I DON'T AGREE” option.
If Realtor proceeds with a good prospect, DISCLOSURES may come up with an “I AGREE” or “I DON'T AGREE” option. These may be provided for example by Al la Mode. This may also send a form e-mail to a supervisor's e-mail, or co-worker's address that the customer provides in the loan application to verify employment (VOE) with a copy sent to Realtor's in-box, and may place it in a folder w/customer name, and may also send a copy to the administrator of the web-based software for record purposes.
2) Services Application fill-out with disbursement of data to the various forms. Create a customer login, auto-create a folder in their e-mail, Pre-Qualify w/answer for Realtor regarding if this is a prospect they can work with now. At this point, the customer is in the Realtor's CRM database.
3) SERVICES PRESENTATION BEGINS (Optional, but also may increase affiliate partnership orders).
Services Presentation Slide 1: Realty Control, Inc. (RCI) cover slide. General info of administrator company or Realty Co.
Services Slide 2: Explanation of Appraisal necessity. (Option to Order service from affiliate partner)
Services Slide 3: Explanation of Inspection necessity. (Option to Order from service affiliate partner) Etc.
This portion of the presentation may provide an option to order an appraisal (as soon as address is provided) with a form e-mail to our appraisal company in the area, and a home inspection—copy sent to Realtor's inbox folder of customer. This may be a separate option from the Realtor's home template in the virtual office, or ingrained in the presentation, with a click-box. When the buyer finds a property they like, they may be able to enter the address, and the system may auto-order an appraisal, and a home inspection that may be required by lender . . . etc.
Services Slide 4: TITLE EXPLANATION:
When a purchase or listing address is provided, the system may send a form e-mail to a chosen title company representative with the address and customer name, asking for title services that are necessary according to Land Title—Title Searches, Title Examinations, Abstract Preparation, Insurability Determinations, and the issuance of Title Commitments and Title Insurance Policies—BY NAME. The system may also send a 2nd e-mail, to the title company, asking about property taxes for that specific property with the customer's contact and the Realtor's contact.
Services Slide 5: Explain possible attorney needs, and ask for availability of 1003, paystubs, etc. for when Realtor's assistant calls.
Explain the needs of a contract. E-mail PDF of all disclosure copies to customer's e-mail address provided in the loan app. Send e-mail to Realtor and Administrator that these have been delivered. Explain that Realtor or Assistant will be there at closing, as well as RCI assistant.
Auto-Populate the data into Calyx or Encompass, or managing technology, at this point, and if customer agreed, auto-pull credit, or order it via form e-mail(RESPA 7).
Services Slide 6: Explanation of mortgage insurance, explanation of hazard, flood, casualty insurance. Flood zones, etc. (Option to Order Service)
INFO:
Option to go through our GEoA co-op affiliated business network. Can be ordered, or provided by prospect's insurance company. If ordered through us, send form e-mail requesting information, and follow-up contact regarding these services. Copy the Realtor's e-mail we provide (and sent to customer folder), and agent's e-mail.
Services Slide 7: Explain mortgage life and disability insurance. Explain not necessary by lender in Colorado as condition of loan, but ask if interested . . . if “Yes” auto form e-mail our contact at Insurance Firm X.
Services Slide 8: Explain Property Taxes, assessments, or charges on real property. Auto E-mail, separately, to the Title Company contact, a request of property taxes on the property with contact info of prospect, property's address, etc. CC the Realtor, in their customer folder and administrator, and prospect's e-mail.
Services Slide 9: Closing Expectations. By now, a CRM entry should have been populated, numerous e-mails sent to title company, our applicable agents, appraisal company, inspection company, Realtor, customer, potentially life agent, etc. This qualifies for Broker Agency.

These are examples of integrated presentations with consumer education and options to initiate orders for services immediately.

Having gone through the presentation, the system may have captured an ‘agency agreement’ formalizing the relationship. Having established Broker-Agency, a realtor may then utilize a pre-qualifying system, incorporated into the system, to determine the eligibility of their prospect. In addition, the CRM system 60 may be self-organizing and may add much of the data and accomplish most data entry and transmission work. By filling out a complete loan application, the Realtor may satisfy the main RESPA guideline in order to receive a flat processing fee (e.g. $50) for eligible customers' data files—allowing much of a loan officer's duties to be superseded. This may save the consumer typically 1% ( e.g. the commission otherwise payable to a loan officer), sometimes more, on the sales price of their home. This short, mini-app may be designed to determine whether the client would likely be eligible for a loan to buy a house. As one of the determinates that may present the user 20 of this system with less economic gain may be prospects who cannot qualify for a loan, the system may incorporate a basic credit check, which allows the Realtor to know immediately whether they likely have a qualified prospect or not. This aspect of the system may save the realtor a lot of time and money, thus providing another economic incentive to the user of this system.

In this example of the method and system, when the realtor fills out this mini-app, the system may promptly transfer it to the user's affiliated Purchase Coordinator/Transaction Coordinator 22, who may contact the prospective mortgage applicant quickly and begin working the Transaction. This direct transfer may allow the information required in determination of the prospective customer's loan to be sent with minimization of chance misplacement or delay, or lessening security conditions. In the present embodiment, this Purchase Coordinator 22 may assist the realtor on all purchase transactions. Through the system's capacity to group various components for a transaction, and identify the load that allows functions to be optimized, each Purchase Coordinator/Transaction Coordinator 22 may be assigned a limited amount of transactions per month. The system may be customized so that incentives are inputted to create a unique method of compensation to any support function of the system's user group. This allows for improved performance to be achieved, based on completion of the user's needs, leading to an economic benefit to the user 20. The improved performance including such things as: close of the loan in a timely manner, defined as any number of days depending on each industry and situation, but specifically, 14-30 days, unless an extension for extenuating circumstances is requested by the Realtor or Home Buyer.

In this example, the Purchase Coordinator/Transaction Coordinator 22 may take the place of a dozen or more faces that the end consumer 26 may otherwise deal with including: Title 28, Mortgage 30, Inspection 32, Contracting 50, Telecommunications 48, Moving and Transportation, Appraisal 34, Insurance 42, Contracting 50, Legal 36, Financial, Accounting 46 and other considerations. In this example, the purchase coordinator 22 may be the only other face, aside from the realtor, who deals with the consumer 26. The purchase coordinator 22 may be the facilitator of the process, which may result in less confusion and communication issues in the process. This position may help the Realtor make sure that all the documents and necessary business has been achieved in time for the closing table. The loan and the contract, applications, service orders, and title, inspection, etc. may be worked and coordinated simultaneously to achieve a shorter sales cycle for the Realtor, and better experience for the consumer 26.

By use of this system, a user 20 may be able to gain advantages in the marketplace by showing consumers 26 that while others may require waits of up to 30 days or more by traditional processing methodology, the system allows the user 20 to provide quicker service by having delivery of the service in as little as 14 days enhancing the possibility of an accepted offer. The added economic value of the system, with many prospects determining that a 14 day clear to close gets them into their desired objective (in this example a home) significantly quicker, is a unique advantage to this system.

In this respect, the system may allow there to be less interface requirements by the consumer 26 until close of the primary transaction. In the real estate industry, the web-based interface 15 may provide an easy to use interface 15 on the backside that will interface with other key service providers 24 for this example's industry, the lender's loan tracking program, such as Calyx or Encompass. In this respect, the system may allow for seamless upload to web server when new data is entered, so the Realtor and Home Buyer can have access to online real 24/7 Transaction tracking through their individual log-ins. In one aspect of the system, the Realtor may create a temporary login to the site when they receive the mini-app for the homebuyer. This login may allow the homebuyer access to their information and important dates in-line to complete the transaction. Thus they may avoid calling their Realtor or having to track down their service providers 24 for answers. Instead they may be able to log on, online, and check it themselves.

In this respect the system may eliminate many of the multiple (400+phone calls in the typical real estate transaction) calls that are made to close a transaction for the Realtor. As the system consolidates the communication and document tracking functions for the transaction, minimal contact points are required of a consumer 26 of a user 20 of the system (a buyer of real estate in the example has only to deal with the Purchase Coordinator 22 who handles the bulk of the paperwork in the transaction, and may be available, at their desk, from 8am to 5:30pm+every day if the Realtor or their client has any questions). This aspect of the system, may increase users' marketing value to their consumers 26 as the system provides a greater amount of comfort to the user's consumer (Home Buyer/Seller), only dealing with two ‘faces’, minimizing confusion, in what for most can be a daunting or intimidating transaction. The system may allow most of the questions to be answered with a quick link to the web-based interface 15.

The system may be adaptable to any variety of industry applications. It is noted that, in the real estate example, the Purchase Coordinator 22 fulfills multiple positions. On purchase transactions, the purchase coordinator 22 fulfills the role of a Transaction Coordinator, Loan Underwriter, Loan Processor, Courier, and Technical/Personal Assistant or representative at the closing table. As such, other industries may also integrate key functions into the systems adaptable process.

An additional aspect of the system, based on a real estate example, is that even if a user's 20 prospective consumer 26 is not eligible to purchase a home during the first application over the system, the system linkage may further provide a support system by initiating a “Credit Cleanup” Program, screened and hand-chosen through affiliate partners, designed to get the prospect qualified as soon as possible. In this example, in six months, or however long it takes, the Purchase Coordinator 22 may then call the Realtor with the news that their prospect is now qualified and ready to go shopping, furthering the economic advantage to the user 20 of the system over other technologies that are not integrated.

Use of the CRM database 60 may allow users 20 to track their clients. They may auto-mail, e-mail, look-up, take notes and contact their prospects/associates through this database 60 and they may be linked with the aforementioned features: Auto-Mailer 66/E-Mailer 62/Notes Field 90, groups, events, tasks 68, instant messages, and important e-mails. They may all be LINKED seamlessly, allowing all pertinent information/interactions with a client at a glance summary, eliminating much digging up various transactions, e-mails, and papers.

The Realtor may have a login to the site, allowing him or her numerous resources, that allows Realtors to keep track of current and past clients. Through the web-based interface 15, the user 20 may access a detailed, comprehensive, and easy to use database system. In the real estate example, the “Realty Control” website may handle much of the marketing for a user 20 (Realtor). The database may allow contact with all of the Realtors' past and prospective clients in multiple different methods, many different times a year. Auto-mailers 66 on behalf of the user 20 (Realtors), from Realty Control, may be sent multiple times a year. They may include the Realtor's contact information, company logo, photos and a brief message from the Realtor. Mailers 66 may be sent out on the Realtor's behalf on their clients' birthdays, anniversaries, past move-in date, holidays, and any other dates the Realtor specifies. Realtors who wish to contact their clients personally, as well, can receive their lists of clients' special dates via their RealtyControl.net e-mail address and/or web-app, so they can phone the client. This may allow a user 20 to maintain the users' contact with the consumer 26 in many unobtrusive ways. This may allow, in the real estate example, the Realtor to differentiate themselves from competitors. As a realtor targets previous customers for future business, this attribute may allow the 20 user to obtain the maximum potential amount of referrals.

Use of the CRM feature 60 may also allow users 20 to initiate additional business from past clients. In the real estate application example, utilizing drip marketing through their CRM system 60, and video e-mail technology, users of the system (Realtors) may contact past clients about venture groups/opportunities. Grouping and mobilizing these data groups may help facilitate many more transactions because joint ventures can be quickly organized.

The system may also be used as an education platform—through video, or similar presentations—utilizing the same, collaborative, office dynamic. Various features allow the users 20 to access the education from other similar users' experiences that are shared via the systems platform integration technology system. These features include passing documents or files to each other, scheduling meetings with others, timers, and programming of the system to accomplish weekly coaching classes streamed through the web, and in person at office facilities. As other experienced users 20 share information, the invention benefits the network of users 20 from constantly updated, centralized training information: whether the user 20 is a novice or an experienced user.

The system's users 20 may be able to reach certain levels of experience that, once the user 20 is enrolled and completes any customizable training program, they may become a certified user (in the real estate example, the term may be “Realty Control Certified”). An aggressive “push” marketing strategy, unique to the system's platform, may allow any user group to build brand recognition in this unique certification label such that the system will be capable of generating purchase leads that the system's user 20 can apply as incentives for customers. As an example in the real estate application, For every 10 purchase transactions a Realtor completes with RealtyControl.net, we may give them a free lead.

A referral compensation system referred to as ‘Tier 2 ’ may also be included. This may allow Realtors to supplement their income by urging colleagues to join the service. Where a colleague joins, the referring attorney may receive a credit of a first amount. The referral credit may have a second tier. For example, if the referred Realtor refers another Realtor, the original referrer receives a credit of a second amount.

For example, if the first amount is $50 and the second amount is $25, a realtor referring five new realtors would get a $250 credit. Moreover, if each of those five new realtors referred one additional realtor, the original realtor would get an additional $125 credit.

The lessened costs of the bundled services, and the abilities to earn an extra income stream for referrals, and processing may build loyalty in the Realtors that are recruited. In this way, the system may create incentives to provide continued use of the system by target user groups, which otherwise become enticed to move to competitors so as to create impediments to the systems adaptation by wider target users. As an example in the real estate industry, often times the “deal-breaker” to a transaction is when a Realtor has worked a deal with a lender previously and is inclined to use that lender again without looking at the best deal for the customer—this led to the adjustable rate mortgage crisis.

In another aspect of the education capacity of the system, any user 20 may customize the web-based interface 15 for listings and personal marketing, wherein the user 20 (Realtors) can utilize the system's office software and video-technology services to help market themselves. Each user 20 may mail or e-mail customers the pictures and videos of their particular service or product, and record a description of it. The system may allow any fee construction to be included in order to supply the user 20 with additional fee income. These various service add-ons may include video editing for the user 20, e-mail able video Internet presentations, or any other web based service via the systems web-based interface 15. The system may allow the user 20 to mail or email their previous clients from the system's integrated client relations management software and database systems. This aspect of the system may allow the user 20 to manage their time more efficiently. In the real estate example, instead of showing a property 50 different times to 50 different people, the system may help the user 20 compose a short internet video that can be sent out to as many people as the user 20 targets. Thus, the system may allow a user 20 to show, in the real estate example, a property to thousands of people via video e-mail, specified by zip code or other search criteria designed as an integral part of the system's unique platform construction.

The system and method herein described is advantageous for a multitude of reasons. The flexibility of the system to be customized significantly for the applications required by client, for specific industry compliance, may allow the user 20 to have more methods to differentiate the user's service in the marketplace from others. Moreover, savings or increased revenues resulting from the system's compliance capabilities may be passed on to customers of the users 20, thus lowering the costs for consumers 26. Additionally, the system and method is advantageous due to the capability to provide the users 20 with business software functionality, customized to their niche market, such as in the example sited, real estate, that is encompasses the users needs. The web-based aspect of the system and method allows the software to be accessible anywhere in the world, any time, wherever an internet presence is available.

Moreover, by making the software attractive to users 20, the unique aspects of the system and method may be used to attract end-market consumers who are interested in acquiring a loan or other Real Estate related services. Utilizing the technology and software, the customer's information may be forwarded to the inventions various user groups for a fee income stream based model. This may provide all-inclusive access to target consumers that are potential customers to their services, and allow the user 20 to approach the customer through web-based interface 15 of the system. Thus, the system may simplify any process that the targeted user group is attempting to provide a specific consumer group, and thereby may allow services and products to be delivered in a continuous 24/7 environment, minimizing disruption in the deliverable of the user groups to targeted consumers.

The system herein described may create seamless, customizable integration of multiple tasks that, provides improved services to targeted industry services for users 20 that have to oversee complicated transaction based contracting between consumers 26 and businesses as well as consumer 26 to consumer 26 and business to business. Consistent with a “We Come to You Technology” approach, a development team may build a customized module to interact seamlessly with the service provider 24 desired. The single-information capture allows for integration of the information into each module and any specific platform for the industry (In this case, loan files—Calyx and Encompass) so there is no duplicity, there are higher, regulated data security standards, increased efficiency, and decreased possibility for mis-communication or mis-entering of information.

The system may be further advantageous because it provides a user 20 with a package and service, based on web access from any computer or terminal or hand held device, that allows the seamless interaction of many required processes for execution of an efficient management of the user's tasks with a greater amount of convenience and organization to the user 20 than alternative systems. The system services range from technology applications including client database tracking, wireless pre-qualification of clients and personal marketing through novel strategy synergies built into the system's platform.

The system may be further advantageous because it may provide an improved system and method for protecting the integrity of the communications required by standardizing security across all communications venues to complete complex real estate transactions in a simplified and auto generated web based interface 15. The model may include an aggressive anti-virus/anti-spyware/anti-malware on-line version with a corporate grade desktop virus scanner each month for each user—provided by PANDA Security—a leader in Net Security since 1991. This system may also integrate into the web-browser a defense against key-stroke trackers, or malicious tracking cookies before any information is entered into the browser. This may eliminate prying eyes by ensuring security from our lead agent's point of entry system and encrypting it to 256 bit encryption, eliminating sensitive paperwork that is often discarded without proper shredding, leaving consumers' information vulnerable. Our system ensures encrypted data flowing only the pieces of data necessary to each transactional participant at the highest current level of encryption (non-military) to an interface with an affiliate partner, who can accept the data immediately into their system, on their terms. Safety may be provided from the desktop, through the browser, providing heavily encrypted data transmitted through networks to the appropriate affiliates' system, which may be required to upgrade to 256 bit encryption to become a true provider.

A “We Come To You” business service may create a custom module to plug seamlessly into a current ordering interface. These documents may be transmitted to esteemed institutions with lots of security. Once the businesses setup the parameters, the system may be completely encrypted from data entry, to submission through Net or VPN, where it is received still encrypted—with only affiliates knowing how to access their particular system.

The “We Come To You” business service may involve standardization programs by technicians and developers to provide seamless interaction, which may include integrating with a service provider's data submission format with their permission and scripts. The standardization programs may provide a security standardized level of 256 Bit Encryption and may be capable of adjusting the encryption to accommodate a service providers level of encryption. This service may be an all-encompassing, niched business service that is complete, affordable, and easy to use. The system may include a library of Flash Video Tutorials and On-Call Live Support. The system may save time, money, confusion, and frustration. In tough times, many Realtors are looking for second streams of income to stay a float. The above mentioned ‘Tier 2’ referral system, and loan application collection with documents can earn a ‘processing fee’ of ˜$50. These two programs present an opportunity to help re-energize and keep alive a realtor's business, by cutting costs, and emphasizing on a technology presence, to cut marketing costs.

The system provides this user friendly interface by bringing together a complex, technical formula of data exchange software that allows multiple partnerships required to complete the transaction through affiliates to be protected by the unique aspects of the system's capability to integrate the potential network of partnerships with a co-marketing component that may utilize the web technology to link communication, automate and streamline duties, secure private information, and provide wide-accessibility to the pertinent party.

The system may be further advantageous because it combines new, emerging technologies and services, into a singular, user-friendly, web-based, universally accessible, platform-neutral, brokerage-neutral package with an established group of services bundled together with established, function related companies and industries behind it—especially for new Realtors. Moreover, it may automate as many aspects of the transaction as possible (including funds exchanged, correlation and management of related activities, and significant data transfer) to ensure a higher level of profitability to the company and savings to the customer, and more efficient, convenience of communication utilizing code to format and process the application or information, and re-generating this information into the format preferred by the individual member of the network.

The system may be further advantageous because it may format data to industry specifications either through specific file types, text files, e-mails, PDF's, .CSV's, etc. This may increase efficiency as the data is immediately exchanged without previous necessary conversions of data types, manual re-entry, or other inefficient processes.

The system may be further advantageous because it may automate much of the duties of several agents including many duties of: the Loan Officer, the Realtor, the Processor, the Title Agent, the RE Brokerage, the Inspector, the Appraiser, etc. This data may be auto-populated to eliminate the necessary hands that touch and charge a fee on a transaction.

The system may create more profit/margin for the user 20 and less costs for the consumer 26 relying on economy of scale. This is because bulk services may be purchased. For example, 100 title services may be purchased in bulk as opposed to 100 individually, achieving a significant savings for each individual consumer 26, in each individual transaction.

There may also be an option, as our current price point is 15% (85% Discount) of lesser featured competitors, for employing brokers, and mortgage companies, and those affiliated with Realtors to form their own, private branded version, utilizing their respective service, and their special features integrated with ours. They may then re-sell the product to their realtors, inexpensively, to give them tools to compete in the wide marketplace, at a good cost—keeping them alive and participating in the struggling market—while at the same time earning an additional stream of income for the brokerage.

To ensure Realty Law compliance, and not participate in steering, three or more reputable providers of each necessary service could be recruited—and randomized leads distributed as necessary. For example—bids, or a random queue to determine amongst the three companies who the loan or service contract is awarded to.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself. The invention may also be carried out with respect to various businesses other than real estate including, but not limited to insurance, power cooperatives, outside sales, and the like. Real estate was merely used as an exemplary embodiment of the system and method described herein and others will be understood by those skilled in the art.

The description of the various embodiments is merely exemplary in nature and, thus, variations that do not depart from the gist of the examples and detailed description herein are intended to be within the scope of the present disclosure. Such variations are not to be regarded as a departure from the spirit and scope of the present disclosure.

What is claimed is:

1. A system for initiating multi-faceted transactions facilitating ancillary services comprising:
a server connected to a network;
a database; and
a web-based interface configured to allow interaction between the server and a first user connected to the network; wherein the server is configured to:
receive, store, secure, and back-up data;
format the data into at least one of a plurality of formats; and
transmit the formatted data to at least a first service provider connected to the network.

2. The system of claim 1, wherein the at least a first service provider has a “We Come to You” custom module.

3. The system of claim 1, wherein the formatted data is transmitted via e-mail.

4. The system of claim 1, wherein the web-based interface includes a contacts relationship management feature.

5. The system of claim 4, wherein the web-based interface includes a presentation feature.

6. The system of claim 5, wherein the web-based interface is configured to host a website of a user.

7. The system of claim 6, wherein the web-based interface includes a web editor providing “what you see is what you get” website editing capabilities.

8. The system of claim 7, wherein the web-based interface includes search engine optimization for the user's website.

9. The system of claim 8, wherein the web-based interface includes a blog feature for posting items on the user's website.

10. The system of claim 6, wherein the web-based interface includes an auto-mailer feature.

11. The system of claim 10, wherein the web-based interface includes a one location e-mail feature.

12. The system of claim 11, wherein the web-based interface includes a support forum.

13. The system of claim 12, wherein the web-based interface includes a MLS/IDX link.

14. A method for integrating business transactions, comprising:
providing an established group of services;
uploading customer data to a database through a secured, web-based interface;
formatting the customer data to create custom formatted customer data, the formatting to reflect at least one industry specification; and
transmitting the custom formatted customer data to at least one service provider, wherein
the at least one service provider represents one of the established group of services.

15. The method of claim 14, wherein the established group of services have a functional relationship with each other.

16. The method of claim 15, wherein the established group of services all involve separate transactions ancillary to a primary transaction.

17. The method of claim 16, wherein the primary transaction is a real estate purchase or sale.

18. The method of claim 14, wherein the transmitting step is conducted via a “We Come To You” custom and secure module.

19. The method of claim 18, wherein the transmitting step is automatic upon receipt of the uploaded customer data.

20. The method of claim 19, wherein further transactions with the established group of services is conducted by a transaction coordinator or through affiliates' employees.
